(19) United States
(12) Patent Application Publication
(10) Pub. No.: US 2008/0206599 A1
(43) Pub. Date: Aug. 28, 2008

(54) Method for Preparing a Gypsum Composition

(75) Inventors: Philippe Thouilleux, Saint Foy Les Lyon (FR); Jean-Philippe Boisvert, L'Isle D'Abeau (FR); Isabelle Javierre, Four (FR)

Correspondence Address: BUCHANAN, INGERSOLL & ROONEY PC, POST OFFICE BOX 1404, ALEXANDRIA, VA, 22313-1404, US

(73) Assignee: LAFARGE PLATRES, Avignon Cedex 9 (FR)

(21) Appl. No.: 12/065,998

(22) PCT Filed: Sep. 20, 2006
(86) PCT No.: PCT/FR06/02152

§ 371 Date: Mar. 6, 2008

(30) Foreign Application Priority Data
Sep. 22, 2005 (FR) 0509678

(51) Int. Cl. B32B 13/00; C08K 3/30; B32B 37/00

(52) U.S. Cl. 428/703; 524/423; 156/250

(57) ABSTRACT

The invention provides a method for preparing a gypsum composition containing a cross-linked polymer comprising the following steps:
preparing a slurry of the gypsum composition by mixing the various constituents of the composition, or precursors thereof, with water, in a mixer;
hydraulic setting; and
drying and cross-linking in the presence of heat.

The invention applies to the manufacture of gypsum boards.

The invention further provides a composition of gypsum containing a cross-linked polymer, and further comprising a water resisting additive in an amount such that the water uptake is below 10%.

### FIELD OF THE INVENTION

This invention relates to a novel method for preparing a gypsum composition containing a polymer.

### STATE OF THE ART

Gypsum boards and gypsum tiles are known for use in damp environments, containing a hydrophobic agent in order to protect them against dampness. However, and notably in the case of gypsum boards, mechanical properties become degraded in a damp environment. Even if water uptake is satisfactory, the current so-called “Hydro” boards do not have satisfactory mechanical behavior in a damp environment.

WO-A-03/040055 discloses the use of starch and a cross-linking agent in the manufacture of gypsum boards. Cross-linking of the starch takes place inside the board, but this is not achieved by action of the temperature. Cross-linking is described as taking place under the action of a high pH, through the sole presence of the reactive chemical compounds. Drying takes place after cross-linking.

US-A-2002/0128352 discloses a composition designed to be used in gypsum boards, comprising an organic binder which is polymerized in situ in order to form a network. The action of the temperature is not described as associated with the cross-linking. Additionally, placement on a facer type element takes place after setting. This document deals with acoustic panels in which the open porosity is obtained by the action of a swelling agent, which can be physical or chemical.

EP-A-1035088 discloses a mixture of gypsum with a polymer. The polymer is pre-constituted prior to its addition to the gypsum slurry. There is no mention of cross-linking in the slurry and even less of the effect of heat on cross-linking.

DE-A-3721668 discloses a mixture of gypsum and a composition containing epoxy resin, a cross-linking agent and quartz powder. There is no indication of the actual time when cross-linking takes place and there is no mention of application of heat.

U.S. Pat. No. 4,042,409 discloses a gypsum composition containing an emulsion of paraffin and oxidized paraffin and, optionally, a polymer emulsion. The emulsions are prepared prior to mixing with the gypsum. There is no mention of cross-linking.

U.S. Pat. No. 4,021,259 discloses a composition containing gypsum, PVA (polyvinyl alcohol) and a metal. There is no indication concerning the time of cross-linking with respect to the setting, nor of the action of heat or the temperature. Cross-linking takes place in fact here through the simple presence of the chemical compounds.

JP-54-33532 discloses a method for preparing gypsum-based compositions by heating to a temperature of from 60 to 80° C. of a mixture of hemi-hydrate, of a reactive mixture resulting from condensation of a (meth)acrylamide type monomer and urea or melamine and, optionally, formaldehyde, and an initiator. The condensation reactions which take place between the monomers lead to a three-dimensional network but which is not cross-linked (wherein cross-linking can be defined as “a bridging reaction between polymer chains leading to a three-dimensional network”). There is no mention of the action of heat on polymerization by condensation of the monomers. In this document, the composition is left after casting for a time comprised between 5 and 168 hours, after which the composition is submitted to the action of the temperature over a period of time comprised between two and six hours. The minimum cycle duration is consequently seven hours, which is not compatible with industrial production.

JP-53-44489 discloses a method for board preparation from a gypsum-based composition by heating to a temperature of from 50 to 110° C. of a mixture of hemi-hydrate, a (meth)acrylamide type monomer in the presence of an amino resin (or a precursor) and fibers. This document presents a technique which is similar to that described in the previous document and the same comments apply mutatis mutandis thereto. Further, the example involves durations of at least one day, which again makes this method incompatible with industrial production.

The invention therefore aims at improving preparation methods, making it possible in particular to obtain gypsum-based elements having better mechanical behaviour in highly damp environments.

### SUMMARY OF THE INVENTION

The invention thus provides a method for preparing a gypsum composition containing a cross-linked polymer, comprising the following steps:
preparing a slurry of the gypsum composition by mixing the various constituents of the composition, or precursors thereof, with water, in a mixer;
hydraulic setting; and
drying and cross-linking in the presence of heat.

Hydraulic setting has a duration such that drying can start on the outer portions of the object while setting continues in the inner portions of the object. Similarly, typically, the amount of water used at the outset is greater than the amount of water strictly necessary for the hydration reaction. The hydraulic setting reaction can continue while the amount of water present in the medium decreases as a result of drying. The hydraulic setting and drying steps are consequently not exactly sequential but may overlap to a certain extent. Hydraulic setting is typically performed up to at least 80%, advantageously at least 90%, preferably at least 95%. Hydration is measured in a conventional fashion, That is, measurements on a curve which can be the increase in temperature, the increase in weight (or water uptake), the hardening, etc. All conventional methods are suitable.

According to one embodiment, the temperature at which cross-linking is implemented is higher than or equal to 100° C., preferably higher than 120° C. and/or less than 250° C. The temperature which is referred to is the temperature of the atmosphere.

The invention applies to the manufacture of gypsum boards as well as to the manufacture of gypsum tiles.

The invention further provides a gypsum composition containing a cross-linked polymer and comprising, additionally, a water resisting additive in an amount such that water uptake is less than 10%, preferably less than 5%, and advantageously less than 3%.

This composition is useful as a core composition for gypsum boards, comprising a core based on said composition and at least one and, advantageously two facers.

### BRIEF DESCRIPTION OF THE DRAWINGS

FIG. 1 shows the apparatus for measuring breaking strength.

### DETAILED DESCRIPTION OF EMBODIMENTS OF THE INVENTION

The invention uses a gypsum-based composition.

By “gypsum-based composition” is meant here a conventional gypsum composition, i.e. essentially constituted of gypsum.

Herein, by “gypsum” is meant the product resulting from the hydraulic setting and hardening of a hydratable calcium sulfate, i.e. an anhydrous calcium sulfate (anhydride II or III) or a hemi-hydrated calcium sulfate (CSO₄, ½ H₂0) in its various crystalline forms. The preferred crystalline form is the β form, which may or may not be stabilised. These compounds are well known to the person skilled in the art and are generally obtained by burning gypsum. The composition may also comprise other hydraulic binders in small amounts. The core density can vary from 700 kg/m³ to 1100 kg/m³, notably from 750 kg/m³ to 950 kg/m³. The water/gypsum ratio used in the invention is variable; by way of a non-limiting example, it can vary from 0.2 to 1.5, in particular from 0.5 to 1.2 and notably from 0.55 to 1.2.

The composition according to the invention comprises a polymer cross-linked by heat Cross-linking provides a three-dimensional network which provides mechanical properties in the presence of water, by preserving mechanical cohesion within the gypsum matrix. When compared to the above-cited Japanese applications, this difference provides significant advantages (the invention obtains a three-dimensional network solely from monomers or polymer).

The amount of this (cross-linked) polymer can vary over a wide scale, for example from 0.1% to 10%, notably from 1 to 5 weight % with respect to the weight of the final gypsum composition.

The polymer may be used under any form, but it is preferably in the form of a solution or emulsion.

The invention can be carried out principally according to three embodiments:
Polymerization of the monomers (in situ), preferably found in the presence of a cross-linking agent. The gypsum is mixed with a solution containing the monomers.
Post-cross-linking of polymers (in situ) in the presence of a cross-linking agent. The gypsum is mixed with a solution of polymers in the presence of a cross-linking agent.
Self-cross-linking (in situ). Use of heat-sensitive polymers which cross-link simply under the effect of heat, without a cross-linking agent.

Polymerization initiators and cross-linking agents can be used if necessary. Peroxide or azoic or persulfate (of ammonium, aluminum or potassium) type initiators are suitable, and more generally, any molecule that can form free radicals under the effect of temperature.

According to the first embodiment, one can use monomers of the acrylic, vinyl, allyl type and generally any monomer that is miscible with water or can be put into emulsion with water, and able to cross-link under the effect of temperature, preferably in the presence of a cross-linking agent. Acrylic type monomers can be used such as acrylamide and N-methylol acrylamide; methacrylic-type monomers such as methacrylamide; or esters of these monomers such as PEG acrylates and methacrylate (MPEG) or a PEG methylmethacrylate (MMPEG) or a PEG ethylmethacrylate (EMPEG) derivative. Mixtures are possible and advantageous.

Cross-linking agents are typically bi-functional and are for example methylene-bis-acrylamide (MBA) or PEG dimethacrylate (DMPEG). The cross-linking agents get inserted in the main chain during the polymerization reaction, forming bridging between two chains.

The cross-linking agent used is advantageously of a reactivity similar to that of the constituting monomer, and in particular of the same acrylic/acrylic; methacrylic/methacrylic nature.

According to the second embodiment, polymers are used which will post-cross-link by reaction of a cross-linking agent on the pending chemical functions of the polymer, or on certain functions of its main chain. The cross-linking agent is here any chemical molecule able to react with certain functional groups of the polymer. As an example of a polymer able to react according to the second embodiment, partially hydrolyzed polyacrylamides (PHPA, also called anionic) can be cited. These polymers can be post-cross-linked by the action of chromium acetate, the reaction occurring between the carboxylic functions (COO⁻ Na⁺) incorporated during polymer synthesis, to the extent for example of from 0.1 to 5%. One can also use optionally functionalized PVA (having a function able to be cross-linked by temperature) or natural polymers (casein, lysine, etc.). In fact, almost all water-soluble polymers can be used. The use of non-water-soluble polymers can even be considered, in the form of emulsion. Mixtures are possible.

By way of a cross-linking agent, polyethylene glycol diglycidylether (PEGDE), adipic acid, glyoxal or glutaraldehyde, and more generally any bi-functional molecule able to react with the polymer, can also be used.

The molecular weight of the polymer should be relatively low. For example, its molecular weight will be comprised between 1,000 and 500,000 g/mol, preferably between 1,000 and 50,000 g/mol. Mixtures are possible.

Two or three embodiments can be combined.

The amount of polymer will in general be dictated by the viscosity of the aqueous solution obtained by dissolving the polymer in water (in the case of water-soluble polymers). The viscosity of the solution obtained depends on one hand on the polymer concentration and on another hand on its molecular weight. A final concentration in weight, with respect to the gypsum composition's weight, is in general from 1 to 5%, advantageously from 2 to 4%.

According to the third embodiment, polymers are used which will cross-link by themselves during exposure to heat. The pending functions are reactive to heat. Silicated polymers may be cited as examples of self-cross-linking polymers under heat.

In the three embodiments, according to one first alternative possibility, care should be taken so that the monomer or polymer is not substantially polymerizable or cross-linkable in the presence of water, prior to the temperature increase phase. According to a second alternative possibility, this hydrolysis is not necessarily inconvenient; for example, polyacrylamide probably hydrolyses with temperature (at least partially) but this hydrolysis which occurs with temperature only accelerates cross-linking by chromium acetate.

The second and third embodiments involve polymers, which in certain cases are beneficial compared to monomers, because the possible toxicity of monomers is no longer present in the polymer. This consequently facilitates handling of these products.

Water-resisting additives can be added, notably in order to reduce water uptake. By way of examples the following compounds can be cited: latex in general; poly(vinyl alcohol), with or without a minor amount of poly(vinyl acetate); metal resinates; waxes or asphalt or mixtures thereof; non-water-soluble organic thermoplastic materials such as for example bitumens, synthetic thermoplastic resins such as poly(vinyl acetate), poly(vinyl chloride) and vinyl acetate/vinyl chloride copolymer as well as acrylic resins; metallic soaps of resin acids, an alkaline-earth metal salt; mixtures of petroleum waxes, notably in the emulsion form; silicone derivatives such as polysiloxane optionally mixed with aminosilanes; particles of clay coated with silicone derivatives such as polysiloxane.

The amount can vary over a large scale, for example from 0.05% to 5%, preferably from 0.5% to 3 weight % based with respect to the total weight of the core material. In general, the amount is such that water uptake is less than 10%, preferably less than 5% and advantageously less than 3%, according to the EN 520 test (method under item 5.9.2).

The person skilled in the art knows how to adjust this amount for a standard board; notably the water uptake value for a standard board is around 40% or even more but this value can be decreased down to 3% or less by the action of the above additives. If the starting value for the board is lower, this value of 3% or less will be even more easily attainable with a lesser quantity of water-resisting additive.

Such a composition containing both a cross-linked polymer and a water resisting additive is novel as such.

The gypsum-based composition according to the invention can further comprise additives used in a conventional manner in gypsum-based compositions and known to the person skilled in the art. In this respect, setting accelerator agents, setting retarders, binding agents, adhesion agents, plasticizers, water-retention agents, air entraining agents, thickeners, bactericides, fungicides, pH regulators, reinforcement materials, flame retarders and/or fillers may be cited. Highly conventionally, a foaming agent is added to the composition of gypsum slurry before setting. In general alkylsulfates, alkylethersulfates or mixtures thereof may be used.

According to one embodiment of the invention, additionally, air is introduced into the gypsum-based composition, for example by adding a foam or by injecting air directly into the slurry. This foam (or gypsum slurry) can be obtained by using any suitable foaming agent, for example the foaming agent of formula ROSO₃M, as defined on page 14, line 20 to page 15, line 16, of the International application WO 99/08978.

The gypsum composition can further comprise fibers, in particular glass fibers, if needed.

The temperature (of the air or gas) at which cross-linking is carried out is in general higher than or equal to 100° C., preferably higher than 120° C., in general less than 250° C. By way of example, this temperature is comprised between 120 and 250° C.

The gypsum-based composition according to the invention can advantageously be formed as a board with at least one and advantageously two facers, to yield, after hydraulic setting and hardening, a humidity-resistant gypsum board. The facing can be hydrophobic cardboard or fiber mat, in particular glass fiber mat.

Finally, the invention provides a method for the continuous manufacture of gypsum boards, essentially comprising the following steps:
preparing a slurry of the gypsum composition according to the invention by mixing the various constituents of the composition with water in a mixer;
depositing the slurry thus prepared on at least one facer, followed by the forming in a strip with, optionally, covering the upper face of the board using a second facer; notably, forming consists in thinning down the edges of the board;
optionally, forming of the edges of the strip of the gypsum board previously obtained by molding the strip on profiled bands;
hydraulic setting of the gypsum on a manufacturing line while the strip of board passes along a conveyor belt;
cutting the strip at the end of the line, according to determined lengths; and
drying the boards obtained (with cross-linking).

The composition of the gypsum slurry is obtained in conventional manner by mixing the hemi-hydrate with water. The additives can be introduced with the hemi-hydrate in particular when these are in the form of powder or with a portion of the mixing water when they are water-soluble or available in liquid form. If foam is injected into the mixer, the additives can also be optionally present in this foam.

In the case of monomers, these are in general available in liquid form and are simply added to the water, without substantial modification of the viscosity.

In the case of polymers that are self-cross-linking or that cross-link with the help of a cross-linking agent, these are in general available in the form of a solution. One can optionally note an influence on the viscosity of the solution, which is taken into account when the method is carried out.

When a cross-linking agent is used, it can be added in a constituent distinct from the one containing the monomer or polymer, or, on the contrary, be added in the same constituent. In general, the cross-linking agent is added to the mixing water or, optionally, to the aqueous foam if such a foam is used.

Notably, the drying step can be implemented at conventional temperatures for gypsum board manufacture lines. Generally, the duration of drying can be comprised between 30 minutes and two hours. The temperature (of the drying air) is in general higher than 100° C., preferably higher than 120° C., for example, between 120 (or even 150) and 250° C., for at least one section of the dryer.

This temperature, in the conventional dryer for gypsum boards makes cross-linking possible, at least in part. Taking kinetics into account, it is to be understood that this cross-linking can even continue outside the drier, provided the temperature of the boards during storage is still sufficient.

Thus, the invention can be implemented in a conventional gypsum board plant without any major modification of the installed equipment.

The invention also covers the manufacture of gypsum tiles, comprising the steps of pouring the gypsum slurry into a mold and the step of drying and cross-linking. The duration and conditions for drying described above in relation with the manufacture of gypsum boards also apply to this process.

Generally speaking, the setting step (between, on one hand, the production of the slurry and its pouring and, on another hand, the entry into the dryer) has a duration comprised between 2 and 30 minutes, preferably between 3 and 20 minutes. Typically, in the case of a gypsum board, the step of beginning hydration up to the cutting conventionally lasts a few minutes, typically around 3 or 4 minutes or more, the following step of damp transfer and end of hydration until entering the drier last from 5 to 10 minutes.

### EXAMPLES

The following examples illustrate the invention without limiting it.

Small bars of gypsum, size 20×2×2 cm were prepared by mixing hemi-hydrate with water in a water/gypsum ratio of 0.8. Setting occurred within 15 to 20 minutes. The sample was then submitted to heat curing for up to five hours, preferably two hours at 90° C. at 100% relative humidity, followed by drying at 45° C. for 24 hours.

The mechanical properties in the damp state were measured after immersion in the water at 23° C., during two hours. The water uptake was also measured.

### Examples 1-9

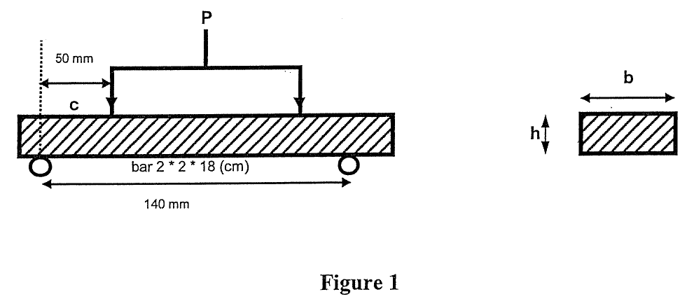

Monomers were used at variable concentrations, with cross-linking agents at variable concentrations. The monomer concentration is given relative to the weight of hemi-hydrate involved while the cross-linking agent concentration is given in ppm relative to the amount of monomer. The following results were obtained. The values of breaking strength are given in MPa. The uncertainty of the values is below 15%. The experimental set-up allowing measurements of the breaking strength is illustrated in FIG. 1. The speed of movement of the force measurement probe was 1 nm/min.

Breaking strength is defined as follows:

Breaking strength (MPa)=3Pc/bh², where P is the force at breaking.

In table 1 below, 8% acrylamide was used with respect to the hemi-hydrate. The amounts of methylene-bis-acrylamide (MBA) are given in ppm with respect to the organic addition. Ammonium persulfate was used as an initiator at 0.1% with respect to the hemi-hydrate. Example A is a pure hemi-hydrate.

TABLE 1

| Ex | MBA (ppm) | Dry (MPa) | Damp (MPa) | Water uptake (%) |
|---|---|---|---|---|
| A | — | 3.96 | 1.57 | 9.5 |
| 1 | 50 | 11.50 | 3.44 | 11.8 |
| 2 | 500 | 14.83 | 4.29 | 8.4 |
| 3 | 1,000 | 13.20 | 5.26 | 7.9 |
| 4 | 2,000 | 14.22 | 5.29 | 9.1 |
| 5 | 4,000 | 11.47 | 3.79 | 10.8 |

In table 2 below, varying amounts of acrylamide were used with respect to the hemi-hydrate. 1,000 ppm MBA was used as a cross-linking agent.

TABLE 2

| Ex | Acm (%) | Dry (MPa) | Damp (MPa) | Water uptake (%) |
|---|---|---|---|---|
| A | — | 3.96 | 1.57 | 9.5 |
| 6 | 8 | 13.34 | 4.89 | 9.4 |
| 7 | 6 | 11.03 | 3.54 | 11.6 |
| 8 | 4 | 9.09 | 3.35 | 11.6 |
| 9 | 2 | 4.17 | 1.74 | 38.6 |

### Examples 10-12

This time, the PEG methacrylate (MPEG) or a PEG methylmethacrylate derivative (MMPEG) was used as the monomer, of variable molecular weight, which is given between brackets in the examples.

200 ppm, of PEG dimethacrylate (DMPEG), based on the organic addition, was used as the cross-linking agent. An initiator was used in an amount of 0.1% APS (ammonium persulfate) based on the hemi-hydrate, except in example 13 in which 0.1% of azoic V50 from DuPont was used.

The results are given in Table 3 below.

TABLE 3

| Example | Monomer | Dry (MPa) | Damp (MPa) | Water uptake (%) |
|---|---|---|---|---|
| A | — | 3.96 | 1.57 | 9.5 |
| 10 | MPEG 360 | 4.40 | 2.33 | 20.6 |
| 11 | MMPEG 300 | 4.18 | 2.20 | 15.5 |
| 12 | MMPEG 1100 | 3.94 | 2.31 | 8.7 |

### Examples 13-15

This time, a 50/50 mixture (by weight) of PEG methacrylamide and methyl methacrylate (MMPEG) of molecular weight 1,100 (MMPEG 1100) was used as a monomer. Methylene-bis-acrylamide (MBA) or PEG dimethacrylate (DMPEG) at variable concentrations were used as the cross-linking agent. The table gives the concentration in ppm between brackets.

The results are given in Table 4 below.

TABLE 4

| Example | | Dry (MPa) | Damp (MPa) |
|---|---|---|---|
| A | — | 3.96 | 1.57 |
| 13 | MBA (500) | 5.80 | 2.20 |
| 14 | MBA (1000) | 5.73 | 2.48 |
| 15 | DMPEG (1000) | 6.44 | 2.58 |

### Examples 16-18

Here, methacrylamide (MACM) was used as a monomer at a concentration of 8%. For the cross-linking agent, PEG dimethacrylate (DMPEG) at a concentration of 1,000 ppm was used. A mixture of polysiloxane and aminosilane in a proportion of 3:1 was used as a hydrophobic agent. The total concentration of this mixture was here 0.7% with respect to the hemi-hydrate. The results are given in Table 5.

TABLE 5

| | Polysiloxane + | MACM | Water | Dry | Damp |
|---|---|---|---|---|---|
| Ex | aminosilane (%) | (%) | uptake (%) | (MPa) | (MPa) |
| A | — | — | 38 | 3.96 | 1.57 |
| 16 | 0.7 | — | 2 | 3.64 | 1.76 |
| 17 | — | 8 | 33 | 8.46 | 2.30 |
| 18 | 0.7 | 8 | 3 | 5.84 | 2.41 |

### Examples 19-20

Varying amounts of polyacrylamide (PACM) of low molecular weight were used. 0.3% of chromium III acetate based on hemi-hydrate was used as a post-cross-linking agent. The results are given in Table 6.

TABLE 6

| Ex | PACM (%) | Dry (MPa) | Damp (MPa) |
|---|---|---|---|
| A | — | 3.96 | 1.57 |
| 19 | 3.2 | 7.85 | 0.89 |
| 20 | 4.0 | 7.85 | 3.24 |

1. A method for preparing a gypsum composition containing a cross-linked polymer, comprising the following steps:
preparing a slurry of the gypsum composition by mixing the various constituents of the composition, or precursors thereof, with water, in a mixer;
hydraulic setting; and
drying and cross-linking in the presence of heat.

2. The method according to claim 1, in which the temperature at which cross-linking is carried out is higher than or equal to 100° C.

3. The method according to claim 1, in which the gypsum composition contains between 0.1% and 10% of the cross-linked polymer, with respect to the weight of the final gypsum composition.

4. The method according to claim 1, in which the cross-linked polymer is obtained by cross-linking monomers in the presence of a cross-linking agent.

5. The method according to claim 1, in which the cross-linked polymer is obtained by post-cross-linking a polymer in the presence of a cross-linking agent.

6. The method according to claim 1, in which the cross-linked polymer is obtained by self-cross-linking of a starting polymer.

7. The method according to claim 1, in which the gypsum composition contains a water resisting additive in an amount such that the water uptake is less than 10%.

8. The method according to claim 1 for preparation of a gypsum board comprising a core based on the said gypsum composition and at least one, advantageously two, facers, the aforementioned method comprising the following steps:
preparing a slurry of the gypsum composition as specified in claim 1 by mixing the various constituents of the composition with water, in a mixer;
depositing the slurry thus prepared on at least one facer, followed by the forming in a strip with, optionally, covering of the upper face of the slurry using a second facer;
optionally, the forming of the edges of the strip of the previously obtained board by molding the strip on profiled bands;
hydraulic setting of the gypsum on a manufacturing line while the strip of the board passes along a conveyor belt;
cutting the strip at the end of the line, according to determined lengths; and
drying the boards obtained and cross-linking.

9. The method according to claim 8, in which the temperature of the drying air is, for at least one section of the drier, comprised between 150 and 250° C.

10. The method according to claim 8, in which air is additionally introduced into the gypsum-based composition.

11. The method according to claim 1 for preparation of gypsum tiles comprising a core based on the aforementioned gypsum composition, the aforementioned method comprising the following steps:
preparing a slurry of the gypsum composition as specified in claim 1 by mixing the various constituents of the composition with water, in a mixer;
depositing the slurry thus prepared in at least one mold;
hydraulic setting of the gypsum in the aforementioned mold;
drying the tiles obtained and cross-linking.

12. The composition as defined in claim 1, the aforementioned gypsum composition further comprising a water resisting additive in an amount such that the water uptake is less than 10%.

13. Gypsum board comprising a core based on the composition according to claim 12 and at least one facer.

14. The method according to claim 1, in which the temperature at which cross-linking is carried out is higher than or equal to 120° C. and lower than 250° C.

15. The method according to claim 1, in which the gypsum composition contains between 1 to 5 weight % of the cross-linked polymer, with respect to the weight of the final gypsum composition.

16. The method according to claim 1, in which the gypsum composition contains a water resisting additive in an amount such that the water uptake is less than 5%.

17. The method according to claim 1, in which the gypsum composition contains a water resisting additive in an amount such that the water uptake is less than 3%.

18. The composition as defined in claim 1, the aforementioned gypsum composition further comprising a water resisting additive in an amount such that the water uptake is less than 5%.

19. The composition as defined in claim 1, the aforementioned gypsum composition further comprising a water resisting additive in an amount such that the water uptake is less than 3%.

20. The method according to claim 2, in which the cross-linked polymer is obtained by cross-linking monomers in the presence of a cross-linking agent.
